(19) United States
(12) Patent Application Publication
(10) Pub. No.: US 2022/0229999 A1
(43) Pub. Date: Jul. 21, 2022

(54) SERVICE PLATFORM FOR GENERATING CONTEXTUAL, STYLE-CONTROLLED RESPONSE SUGGESTIONS FOR AN INCOMING MESSAGE

(71) Applicant: Palo Alto Research Center Incorporated, Palo Alto, CA (US)

(72) Inventors: Jesse Vig, Los Altos, CA (US); Kyle Dent, San Carlos, CA (US)

(73) Assignee: Palo Alto Research Center Incorporated, Palo Alto, CA (US)

(21) Appl. No.: 17/152,338

(22) Filed: Jan. 19, 2021

(51) Int. Cl. G06F 40/56; G06F 40/35; H04L 12/58

(52) U.S. Cl. CPC G06F 40/56; H04L 51/18; H04L 51/16; G06F 40/35

(57) ABSTRACT

An apparatus (100) that automatically generates suggested responses to an incoming natural language communication includes: a classifier (170) that has been trained to predict one or more style attributes exhibited by natural language communications; a generative natural language model (180) that has been trained to generate responses to natural language communications; and at least one processor which executes computer program code from at least one memory, wherein the at least one memory and the computer program code are configured, with the at least one processor, to cause the apparatus to perform defined operations. Those operations at least include: receiving the incoming natural language communication; determining, with said trained classifier (170), one or more style attributes exhibit by the incoming natural language communication; and generating a set of responses to the incoming natural language communication in accordance with the trained generative language model (180), wherein the responses in the set of responses being generated are caused to exhibit one or more style attributes based upon the one or more style attributes determined by the classifier (170) to be exhibited by the incoming natural language communication.

### BACKGROUND

The present specification relates to natural language processing. It finds particular application in connection with the automatic generation and suggestion of a response to an incoming communication and accordingly it will be described herein with reference thereto. It is to be appreciated, however, that it also may be employed in connection with other like applications.

When replying to an e-mail message, some e-mail platforms, clients and/or applications, e.g., such as Gmail, are provisioned to optionally suggest one or more responses that a user may select to use for the given reply. Gmail's automated response generation tool is commonly known as “Smart Reply.” However, conventional automated response generation tools can be limited in one or more respects.

Commonly, a response generation tool will suggest or propose a response which is generally a relatively short phrase (e.g., from one to a few words long) that is drawn from a limited and/or otherwise finite set of predefined phrases. Conventional automatic response generation tools have been confined to a specific communication channel (e.g., e-mail), to a specific platform (e.g., Gmail) and/or are only made available to third party developers as part of an on-device kit (e.g., a software development kit (SDK)). Moreover, traditional automatic response generation tools have not been as robust as a user may desire, e.g., failing to sufficiently account for a historical context of a conversation, lacking desired style control, etc.

According, there is described herein an inventive method, device and/or system to address the above-identified concerns.

### BRIEF DESCRIPTION

This Brief Description is provided to introduce concepts related to the present specification. It is not intended to identify essential features of the claimed subject matter nor is it intended for use in determining or limiting the scope of the claimed subject matter. The exemplary embodiments described below are not intended to be exhaustive or to limit the claims to the precise forms disclosed in the following Detailed Description. Rather, the embodiments are chosen and described so that others skilled in the art may appreciate and understand the principles and practices of the subject matter presented herein.

One embodiment disclosed herein is an apparatus that automatically generates suggested responses to an incoming natural language communication. The apparatus includes: a classifier that has been trained to predict one or more style attributes exhibited by natural language communications; a generative natural language model that has been trained to generate responses to natural language communications; and at least one processor which executes computer program code from at least one memory, wherein the at least one memory and the computer program code are configured, with the at least one processor, to cause the apparatus to perform defined operations. Those operations at least include: receiving the incoming natural language communication; determining, with said trained classifier, one or more style attributes exhibit by the incoming natural language communication; and generating a set of responses to the incoming natural language communication in accordance with the trained generative language model, wherein the responses in the set of responses being generated are caused to exhibit one or more style attributes based upon the one or more style attributes determined by the classifier to be exhibited by the incoming natural language communication.

Another embodiment disclosed herein relates to a method for automatically generating suggested responses to an incoming natural language communication. The method includes: training a classifier to predict one or more style attributes exhibited by natural language communications; training a generative language model to generate responses to natural language communications; receiving the incoming natural language communication; determining, with the trained classifier, one or more style attributes exhibit by the incoming natural language communication; and generating a set of responses to the incoming natural language communication in accordance with the trained generative language model, wherein the responses in said set of responses are generated so as to exhibit one or more style attributes based upon the one or more style attributes determined by the classifier to be exhibited by the incoming natural language communication.

Numerous advantages and benefits of the subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation.

### BRIEF DESCRIPTION OF THE DRAWINGS

The following Detailed Description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing a response generator in accordance with an exemplary embodiment disclosed herein.

FIG. 2 is a diagrammatic showing a training and/or initialization of the response generator shown in FIG. 1 in accordance with an exemplary embodiment disclosed herein.

FIG. 3 is a diagrammatic showing utilization of the trained response generator shown in FIG. 1 in accordance with an exemplary embodiment disclosed herein.

### DETAILED DESCRIPTION

For clarity and simplicity, the present specification shall refer to structural and/or functional elements, relevant standards, algorithms and/or protocols, and other components, methods and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

In general, the present disclosure relates to an automated response generation service that suggests one or more responses to a natural language communication. For example, the service may be made available by a service provider to a user of the service. Suitably, the service accepts the following input arguments: an incoming natural language communication (e.g., an e-mail message, a text message, a chat message, or voice message, etc.); a conversation history (optionally); style parameters (optionally, e.g., a level of formality); and, a domain-specific text (optionally, e.g., text from a product website that reflects a desired style of response). In response, it returns to the user a set (i.e., one or more) of contextually relevant but diverse suggested responses to the incoming communication.

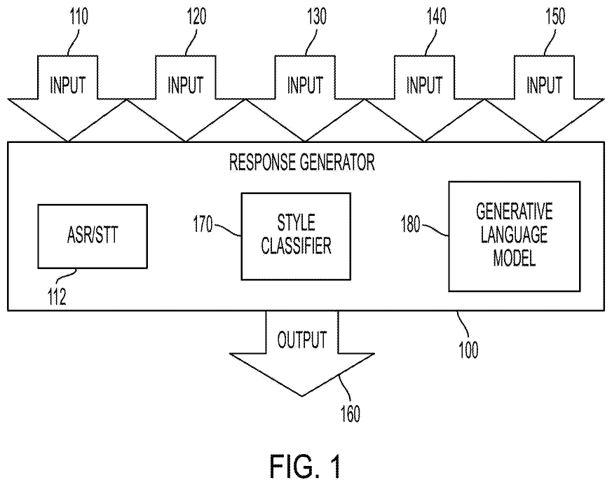

With reference to FIG. 1, there is illustrated an exemplary response generator 100 (e.g., suitably embodied as or in a computer or other like data processing hardware) that automatically generates one or more suggested responses to an incoming communication based upon an array of inputs 110-150. As shown, the array of inputs includes: a first input 110 which receives the incoming natural language communication for which a user desires the suggest response(s); a second optional input 120 which receives the conversation history of which the incoming communication is a part; a third optional input 130 which receives one or more style parameters which a user desires to employ in regulating an output style of suggested responses; a fourth optional input 140 which receives domain-specific text related to and/or associated with the incoming communication; and, a fifth optional input 150 which receives a flag or the like that indicates a user's desired relative output style for the response(s) being suggested. In response to the inputs, the response generator 100 automatically generates and/or otherwise provides to as an output 160, a set (i.e., one or more) of contextually relevant but diverse suggested responses to the natural language communication provided as the first input 110.

In practice, the response generation service is platform and/or communication channel independent or agnostic. That is to say, the first input 110 may be provided in the form of an e-mail message, a chat message, a text message, a voice message, etc. In the case of a voice message, the response generator 100 includes an automatic speech recognition (ASR) service and/or speech to text (STT) processor 112 which converts the input audio voice message to text prior to further processing.

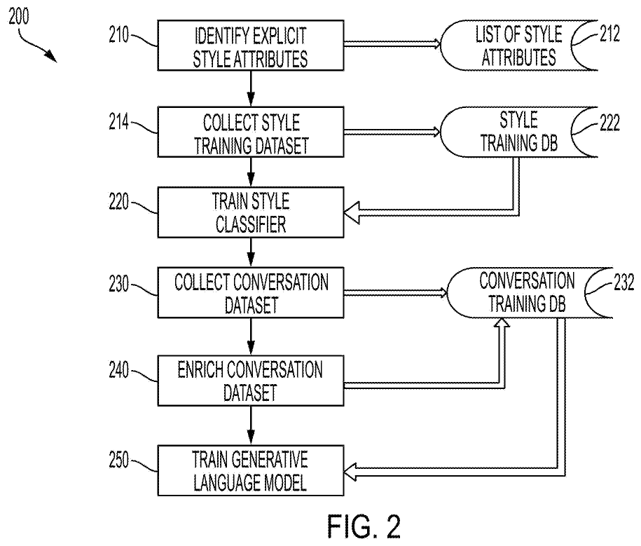

With additional reference to FIG. 2, a diagram is provided to illustrate an exemplary process 200 for training and/or otherwise initializing the response generator 100.

As shown, the process 200 begins with a step 210 of establishing and/or identify a list of explicit style attributes. For example, the list may be stored and/or maintained in a database (DB) or memory 212. The explicit style attributes identified and/or otherwise established in the list indicate the ways in which a user may wish to classify incoming communications according to their exhibited style. For example, the style attributes may include, without limitation, politeness, mood, formality, language complexity, verbosity, etc. In practice, the style attributes of interest are established and/or identified by manual entry and/or selection, e.g., by either the service provider and/or the user.

At step 214, a sufficiently large dataset of “gold-standard” or style training records are collected, established and/or otherwise maintained in a style training database (DB) 222. Suitably, each record includes the text of an exemplary communication, along with an identification of one or more style attributes that are ascribed to the exemplary communication, i.e., those one or more style attributes that the exemplary communication is known to exhibit.

At step 220, a style classifier 170 is trained using the dataset from the DB 222. In practice, using the dataset from the DB 222, the style classifier 170 is trained to predict whether text exhibits one or more of the identified style attributes.

In general terms, the training of the style classifier 170 is achieved by processing the dataset from the DB 222 therewith. That is to say, the style classifier 170 processes the exemplary communications from the DB 222 and assigns one or more style attributes to the exemplary communications in accordance with a process and/or algorithm run or otherwise executed by the classifier 170. The style attributes determined and/or assigned by the style classifier 170 are then compared to and/or cross-checked against the actual known style attributes ascribed to the exemplary communications in the DB 222. When the style attributes determined by the classifier 170 for the exemplary communications do not sufficiently match those known style attributes ascribed thereto in the DB 222, the process and/or algorithm run by the style classifier 170 is suitably altered and/or adjusted and the dataset from the DB 222 is re-processed by the classifier 170. Suitably, this re-processing is iteratively executed and/or carried out until the style attributes predicted and/or assigned by the style classifier 170 for the exemplary communications sufficiently match (i.e., within some acceptable tolerance or error rate) those known style attributes ascribed to the exemplary communication in the DB 222. For example, the style classifier 170 may in practice be provisioned to implement and/or use Bidirectional Encoder Representations from Transformers (BERT) or the like.

Additionally, as shown in FIG. 2, at step 230 conversational datasets are extracted and/or otherwise collected from various sources (e.g., chat logs, human-to-human transcripts, etc.) and stored and/or otherwise maintained in a training conversation DB 232. Suitably, each record in the DB 232 represents and/or includes the text of an exemplary conversation (e.g., including both the text of an exemplary incoming communication and the text of the response thereto) that is used to train a generative language model 180 that is employed by the response generator 100 to produce the output suggested responses. In practice, the generative language model 180 may implement and/or employ a Generative Pre-Trained Transformer 2 (GPT-2) or the like.

As shown in FIG. 2, at step 240, the conversational dataset is enhanced, enriched and/or augmented with one or more contributing factors that aid in identifying a context and/or content of each conversation maintained in the DB 232. That is to say, the contributing factors are included in the DB 232 associated with the conversation to which the contributing factors pertain. The contributing factors may be generally thought of as and/or grouped into two types: (1) known contributing factors; and, (2) implied or inferred contributing factors. Suitably, known contributing facts may include certain metadata linked to and/or associated with a conversation. For example, this metadata can include and/or identify without limitation: the communication channel over which the conversation took place (e.g., e-mail, chat, texting, messaging, voice, etc.); the business sector, setting, environment or the like in which the conversation was had (e.g., retail, healthcare, education, etc.); and, the interaction type to which the conversation relates (e.g., technical support, frequently asked questions (FAQ), etc.). The inferred contributing factors may include predicted style attributes for the conversation, e.g., obtained from the trained style classifier 170.

At step 250, the generative language model 180 is trained using the conversation dataset from the DB 232 that has been enriched and/or augmented in accordance with step 240.

In general terms, the training of the model 180 is achieved by processing the dataset from the DB 232 in accordance therewith. That is to say, the model 180 generates proposed responses based on the exemplary incoming communications and contributing factors from the DB 232 in accordance with a process and/or algorithm defined by the model 180. The proposed responses determined and/or generated in accordance with the model 180 are then compared to and/or cross-checked against the actual responses provided in the conversations maintained in the DB 232. When the responses determined in accordance with the model 180 do not sufficiently match those in the DB 232, the process and/or algorithm defined by the model 180 is altered and/or adjusted and the dataset from the DB 232 is re-processed. Suitably, this re-processing is iteratively executed and/or carried out until the responses generated and/or otherwise determined in accordance with the model 180 sufficiently match (i.e., within some acceptable tolerance or error rate) those actual responses maintained in the DB 232.

Having thus trained the style classifier 170 and the generative language model 180, the response generator 100 (provided with and or having access to the same) employs the classifier 170 and model 180 to automatically generate and output a set (i.e., one or more) of contextually relevant but diverse suggested responses to a natural language communication provided as the first input 110 in connection with a run-time operational mode of the response generator 100. That is to say, in the run-time operational mode, the response generator 100 receives and/or accepts inputs 110-150, e.g., entered and/or otherwise supplied by a user, and in response thereto generates or otherwise provides an output 160 based on the received inputs 110-150 in accordance with the processing and/or operations performed by and/or in accordance with the trained classifier 170 and model 180 on the accepted inputs 110-150.

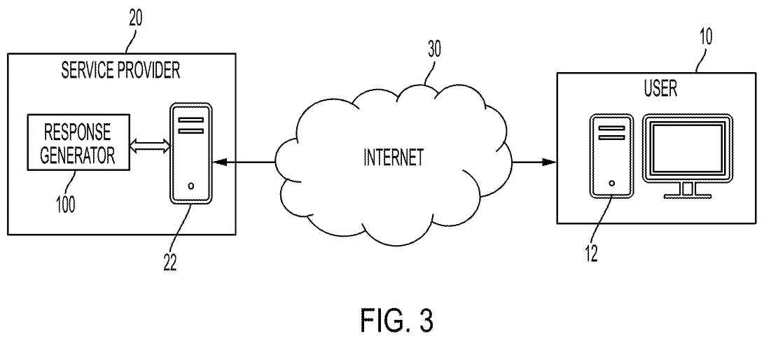

For purposes of illustration, FIG. 3 shows a user 10 utilizing a response generation service offered by a service provider 20 employing the response generator 100.

As shown, the user 10 invokes the service by passing arguments to the service provider 10. These arguments may include, for example, without limitation: an incoming communication for which one or more suggested responses are to be generated, a conversation history (optional) which the communication is a part of, one or more style attributes (optional), a mirroring indicator or flag, etc. In practice, the user 10 may enter or otherwise provide the arguments via a computer, smartphone, smartspeaker, data entry terminal or other like hardware device 12 operatively connected to the Internet or another suitable data communication network 30 over which the arguments are passed to the service provider 20 which operates, maintains and/or otherwise utilizes a hardware server 22 operatively connected to the network 30 for the purpose of providing the response generation service.

Suitably, when received by the service provider 20, the arguments are employed as the inputs 110-150 for the response generator 100.

As discussed above, the trained style classifier 170 predicts one or more style attributes exhibited by the provided incoming communication and labels it accordingly. Suitably, each predicted style attribute determined by the classifier 170 to be exhibited by the incoming communication is mapped to an appropriate style attribute to be used in the suggested response(s) generated (by the response generator 100) and returned to the user 10. Typically, the style attributes used by the response generator 100 for generating the suggested response(s) will be the same as the style attributes that the incoming communication is determined to exhibit. For example, if the provided incoming communication is deemed by the classifier 170 to exhibit a formal style, then the style attribute “formal” will be set for the response; if the provided incoming communication is deemed by the classifier 170 to exhibit an informal style, then the style attribute “informal” will be set for the response, and so on. Suitably, selective use of the flag or mirroring indicator (e.g., set to “true” or “on”) signals to the service provider 20 that this type of style mirroring is what the user 10 desires. Optionally, a set of rules may be established and/or implemented which dictates or regulates an override or exceptions to style mirroring. In practice, the rules may override the selection of style mirroring by the user 10 when an incoming communication is deemed by the classifier 170 to exhibit a particular style attribute. For example, when an incoming communication is deemed by the classifier 170 to exhibit an angry style, style mirroring will be disabled so that the response generator 100 is not triggered to suggest responses in an angry style, but rather a polite or apologetic style is substituted and/or set for generation of the output response.

Ultimately, in one suitable embodiment, a combined context is created from and/or based upon: the provided incoming communication; the conversation history, if specified/provided; the explicit style attribute parameters, if specified/provided; and the mirrored style attribute parameters, e.g., if the mirroring indicator or flag is set to “true” or “on.” Conditioned on this combined context, the trained generative language model 180 predicts a set of m candidate responses. In practice any one or more of various algorithms may be used for the generation of the candidate response, e.g., including top-K sampling. Suitably, to ensure diversity, a subset of n (<m) responses is selected from the set of candidate responses which maximize a diversity metric (e.g., pairwise distance). The selected subset of n responses is utilized as the one or more suggested responses output by the response generator 100. In turn, these n responses are returned from the service provider 20 to the user 10. That is to say, the n responses are transmitted from the server 22 over the network 30 to the device 10.

The above methods, system, platforms, modules, processes, algorithms, devices and/or apparatus have been described with respect to particular embodiments. It is to be appreciated, however, that certain modifications and/or alteration are also contemplated.

It is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements and/or components described herein may suitably be implemented via hardware, software, firmware or a combination thereof. In particular, various modules, components and/or elements may be embodied by processors, electrical circuits, computers and/or other electronic data processing devices that are configured and/or otherwise provisioned to perform one or more of the tasks, steps, processes, methods and/or functions described herein. For example, a processor, computer, server or other electronic data processing device embodying a particular element may be provided, supplied and/or programmed with a suitable listing of code (e.g., such as source code, interpretive code, object code, directly executable code, and so forth) or other like instructions or software or firmware, such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that all such modifications and alterations are included herein insofar as they come within the scope of the appended claims or the equivalents thereof. It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art, which are also intended to be encompassed by the following claims.

What is claimed is:

1. An apparatus that automatically generates suggested responses to an incoming natural language communication, said apparatus comprising:
a classifier that has been trained to predict one or more style attributes exhibited by natural language communications;
a generative natural language model that has been trained to generate responses to natural language communications; and
at least one processor which executes computer program code from at least one memory, wherein the at least one memory and the computer program code are configured, with the at least one processor, to cause the apparatus at least to:
receive the incoming natural language communication;
determine, with said trained classifier, one or more style attributes exhibit by the incoming natural language communication; and
generate a set of responses to the incoming natural language communication in accordance with the trained generative language model, said responses in said set of responses being generated so as to exhibit one or more style attributes based upon the one or more style attributes determined by the classifier to be exhibited by the incoming natural language communication.

2. The apparatus of claim 1, wherein the at least one memory and the computer program code are configured, with the at least one processor, to further cause the apparatus at least to:
select one or more style attributes to be exhibited by the responses in the generated set thereof so that the selected one or more style attributes match those one or more style attributes determined by the classifier to be exhibited by the incoming natural language communication.

3. The apparatus of claim 1, wherein the at least one memory and the computer program code are configured, with the at least one processor, to further cause the apparatus at least to:
select one or more style attributes to be exhibited by the responses in the generated set thereof so that the selected one or more style attributes are different from but complementary to those one or more style attributes determined by the classifier to be exhibited by the incoming natural language communication.

4. The apparatus of claim 1, wherein the style attributes include at least one of politeness, formality, mood, verbosity and language complexity.

5. The apparatus of claim 1, wherein the classifier is configured to implement Bidirectional Encoder Representations from Transformers (BERT).

6. The apparatus of claim 1, wherein the generative language model is configured to employ a Generative Pre-Trained Transformer 2 (GPT-2).

7. The apparatus of claim 1, wherein the at least one memory and the computer program code are configured, with the at least one processor, to further cause the apparatus at least to:
receive a conversation history which the incoming communication is a part of; and
base the responses in the generated set thereof at least in part on the received conversation history.

8. The apparatus of claim 1, wherein the at least one memory and the computer program code are configured, with the at least one processor, to further cause the apparatus at least to:
receive an indication of a communication channel over which the incoming communication was had; and
base the responses in the generated set thereof at least in part on the received indication.

9. The apparatus of claim 8, wherein the communication channel is one of an e-mail communication channel, a text message communication channel, a chat communication channel and a voice communication channel.

10. A method for automatically generating suggested responses to an incoming natural language communication, said method comprising:
training a classifier to predict one or more style attributes exhibited by natural language communications;
training a generative language model to generate responses to natural language communications;
receiving the incoming natural language communication;
determining, with said trained classifier, one or more style attributes exhibit by the incoming natural language communication; and
generating a set of responses to the incoming natural language communication in accordance with the trained generative language model, wherein the responses in said set of responses are generated so as to exhibit one or more style attributes based upon the one or more style attributes determined by the classifier to be exhibited by the incoming natural language communication.

11. The method of claim 10, further comprising:
selecting one or more style attributes to be exhibited by the responses in the generated set thereof so that the selected one or more style attributes match those one or more style attributes determined by the classifier to be exhibited by the incoming natural language communication.

12. The method of claim 10, further comprising:
selecting one or more style attributes to be exhibited by the responses in the generated set thereof so that the selected one or more style attributes are different from but complementary to those one or more style attributes determined by the classifier to be exhibited by the incoming natural language communication.

13. The method of claim 10, wherein the style attributes include at least one of politeness, formality, mood, verbosity and language complexity.

14. The method of claim 10, further comprising:
provisioning the classifier to implement Bidirectional Encoder Representations from Transformers (BERT).

15. The method of claim 10, further comprising:
provisioning the generative language model to employ a Generative Pre-Trained Transformer 2 (GPT-2).

16. The method of claim 10, further comprising:
receiving a conversation history which the incoming communication is a part of; and
basing the responses in the generated set thereof at least in part on the received conversation history.

17. The method of claim 10, further comprising:
receiving an indication of a communication channel over which the incoming communication was had; and
basing the responses in the generated set thereof at least in part on the received indication.

18. The method of claim 17, wherein the communication channel is one of an e-mail communication channel, a text message communication channel, a chat communication channel and a voice communication channel.
